(19) United States
(12) Patent Application Publication
(10) Pub. No.: US 2009/0078794 A1
(43) Pub. Date: Mar. 26, 2009

(54) Nozzle assembly with a filtering member

(76) Inventor: Chin-Chang Cheng, Fongyuan City (TW)

Correspondence Address: PHILLIP LIU, 6980, WHITEOAK DR., RICHMOND, BC, V7EAZ9, CA

(21) Appl. No.: 11/903,703

(22) Filed: Sep. 25, 2007

(51) Int. Cl. B05B 1/14

(52) U.S. Cl. 239/462

(57) ABSTRACT

A nozzle assembly is connected to a pipe and includes an insertion port in which a resilient filtering member is inserted. Teeth are defined in an inner periphery of the insertion port and a diameter of the resilient filtering member is slightly larger than an inner diameter of the insertion port. The teeth press inward an outer surface of the resilient filtering member so as to position the filtering member in the insertion port.

### FIELD OF THE INVENTION

The present invention relates to a nozzle assembly with a tubular filtering member received therein which is positioned by threads defined in the inner periphery of the nozzle.

### BACKGROUND OF THE INVENTION

A conventional cooling device for spraying water particles to cool the air temperature generally includes a pipe which includes multiple nozzle assemblies connected thereto. Water flows through the pipe at a proper pressure and is ejected out from the nozzles. In order to prevent foreign objects such as pebbles to block the orifices of the nozzle assembly, a filtering member is received in the nozzle assembly so as to filter the foreign objects. Most of the filtering members in installed in the nozzle assembly with a certain level of tolerance. However, the pressurized water flow usually removes the filtering member which is twisted or compressed to reduce the volume of water flow. Leakage is then found at the connection area between the pipe and the nozzle assembly.

The present invention intends to provide a nozzle assembly which includes an extension for being connected to the pipe and teeth are defined in an inner periphery of the extension, the filtering member slightly larger than the inner diameter of the extension is inserted into the extension and positioned by the teeth.

### SUMMARY OF THE INVENTION

The present invention relates to a nozzle assembly and comprises an insertion port and teeth are defined in an inner periphery of the insertion port. A resilient filtering member is inserted into the insertion port and the teeth press inward an outer surface of the resilient filtering member.

The primary object of the present invention is to provide a nozzle assembly wherein the filtering member is inserted into an insertion port of the nozzle assembly and the filtering member is positioned by teeth defined in an inner periphery of the insertion port.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the nozzle assembly of the present invention;

FIG. 2 is a perspective view to show the nozzle assembly of the present invention, and

FIG. 3 is a cross sectional view to show the nozzle assembly of the present invention.

### DETAILED DESCRIPTION OF THE PREFERRED EMBODIMENT

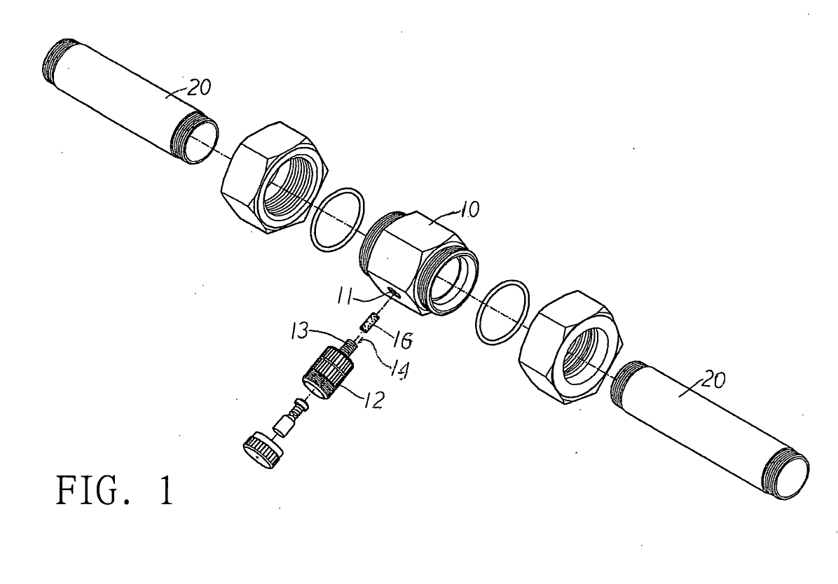

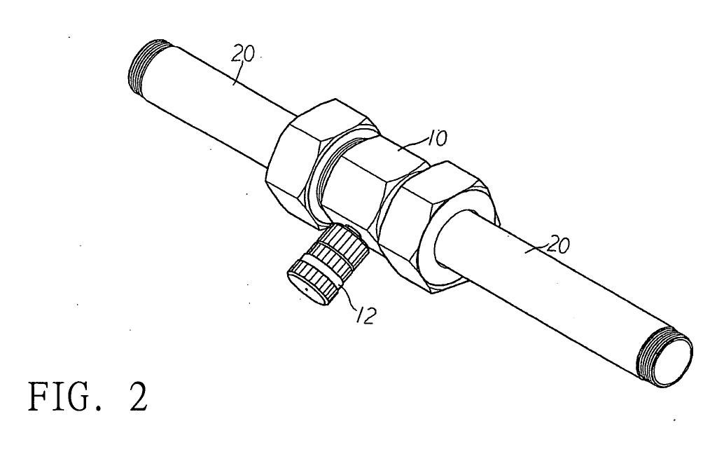

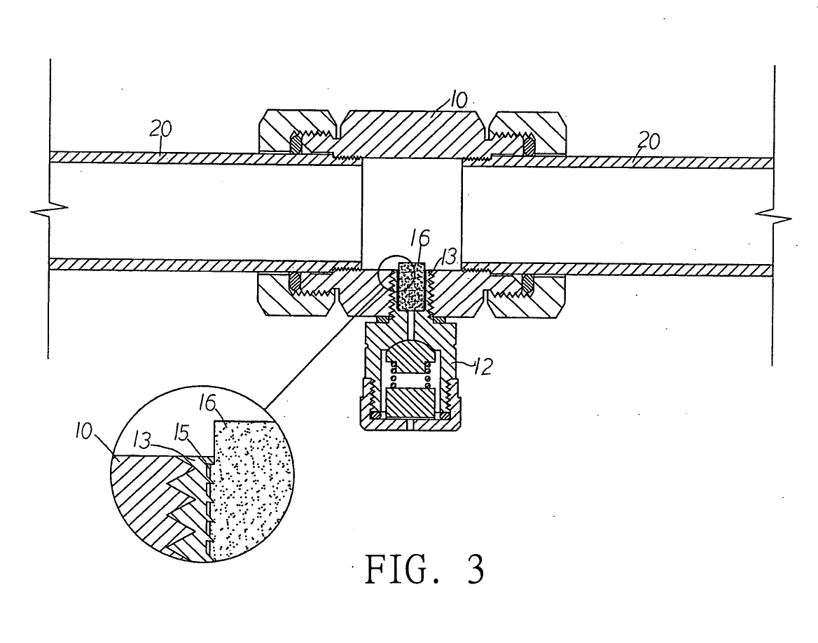

Referring to FIGS. 1 to 3, the nozzle assembly 12 of the present invention is a cylindrical member and a threaded extension 13 extends from a rear end of the nozzle assembly 12. A cap with a hole is threadedly connected to a front end of the nozzle assembly 12. An insertion port 14 is defined in the threaded extension 13 and teeth 15 are defined in an inner periphery of the insertion port 14.

A connection member 10 having tow connection ends so as to be respectively connected with two sections of pipes 20. Water flows through the pipes 20 and enters the nozzle assembly 12.

A tubular and resilient filtering member 16 is inserted into the insertion port 14 and a diameter of the resilient filtering member 16 is larger than an inner diameter of the insertion port 14. The teeth 15 press inward an outer surface of the resilient filtering member 16 so as to position the resilient filtering member 16.

Because the teeth 15 wedge into the outer surface of the filtering member 16, the filtering member 16 is not twisted or compressed by the water pressure.

While we have shown and described the embodiment in accordance with the present invention, it should be clear to those skilled in the art that further embodiments may be made without departing from the scope of the present invention.

What is claimed is:

1. A nozzle assembly comprising:
an insertion port and teeth defined in an inner periphery of the insertion port, and
a resilient filtering member being inserted into the insertion port and the teeth pressing inward an outer surface of the resilient filtering member.

2. The nozzle assembly as claimed in claim 1, wherein a diameter of the resilient filtering member is larger than an inner diameter of the insertion port.

3. The nozzle assembly as claimed in claim 1, wherein the resilient filtering member is a tubular member.
